(19) United States
(12) Patent Application Publication
(10) Pub. No.: US 2011/0163964 A1
(43) Pub. Date: Jul. 7, 2011

(54) Dual type touch display device

(75) Inventor: Tsung-Chieh Cho, Sanchong City (TW)

(73) Assignee: Yen-Lung Tsai & Tsung-Chieh CHO, Taipei County (TW)

(21) Appl. No.: 12/654,886

(22) Filed: Jan. 7, 2010

(51) Int. Cl. G06F 3/041

(52) U.S. Cl. 345/173

(57) ABSTRACT

A dual type touch display device includes a display unit that includes a display panel and a backlight plate. A finger-operation detector is mounted to the display panel of the display unit and a stylus-operation detector is mounted to the backlight plate of the display unit so as to allow the finger-operation detector and the stylus-operation detector to detect the sites of touches applied thereto fore realizing a dual type touch display device that operates with both multiple touch operation and single touch operation. Thus, a single electronic device may realize different types of touch operations of both finger input and stylus input.

### FIELD OF THE INVENTION

The present invention relates to a dual type touch display device, and in particular to a structure of a display unit to which detectors of two types of touch operations are mounted to realize a display device working for dual types of touch operation.

### BACKGROUND OF THE INVENTION

The conventional role of a computer in the everyday living of human beings is for data processing and text processing. With the fast development and progress of the electronic industry, the capacity of a computer is significantly improved, which may include for example network communication and increased speed of data processing, and the outside appearance of the computer is also being continuously and dramatically changed, with a trend toward being compact and light weight. Consequently, the conventional desktop computers are now gradually replaced by portable computers, such as mobile phones, palmtop computers, and personal digital assistants, which effectively reduces the amount of space occupied by the computers and meet the current trend of electronic devices. Further, input devices of the computers are transformed from the conventionally used keyboards or mice to touch panels.

Besides being used in the portable computers as noted above, the touch panels are equally applicable to intelligent electronic devices, such as a touch screen used in an automatic teller machine (ATM). According to the operation modes, the touch panels are generally classified as finger operation devices, including resistive type, capacitive type, and infrared detection type, and stylus operation devices. However, the currently available display device that is provided with touch operation only works for one type of operation, making the operation and use thereof inconvenient. Further although the currently available finger operation touch devices can be operated in multi-touch manner, yet erroneous activation or poor identification often occurs. On the other hand, the stylus operation touch devices provides more accurate touch operation than the finger operation touch devices, but the stylus operation touch devices do not work for multiple touch operations. Apparently, the known touch devices can be further improved.

Thus, the present invention aims to provide a feasible design that overcomes the above discussed problems and drawbacks.

### SUMMARY OF THE INVENTION

An objective of the present invention is to provide a dual type touch display device, which works for both finger operation mode and stylus operation mode and provides both multiple touch operation and single touch operation.

To realize the above objectives, the present invention provides a dual type touch display device, which comprises an enclosure composed of a front cover and a rear cover; a display unit arranged between the front cover and the rear cover and comprising a light source, a display panel, and a backlight plate, the light source being arranged between the display panel and the backlight plate for emitting light toward the display panel; a finger-operation detector, which is arranged on the display panel of the display unit; and a stylus-operation detector, which is arranged on the backlight plate of the display unit, wherein the finger-operation detector and the stylus-operation detector are independently operable to detect a site of touch applied thereto to thereby provide a dual type touch display device that realizes both multi-touch operation and single-touch operation. In this way, a single electronic device can be operated in various operation modes including finger input and stylus input to thereby realize dual types of touch operations, making the operation easy and the cost reduced and ensuring practicability, improvement, and convenience of the present invention.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of a dual type touch display device constructed in accordance with the present invention;

FIG. 2A is an exploded view of the dual type touch display device of the present invention;

FIG. 2B is a side elevational view of a display unit of the dual type touch display device of the present invention;

FIG. 3A illustrates an operation of a stylus-operation detector of the dual type touch display device of the present invention; and

FIG. 3B illustrates an operation of a finger-operation detector of the dual type touch display device of the present invention.

### DETAILED DESCRIPTION OF THE PREFERRED EMBODIMENT

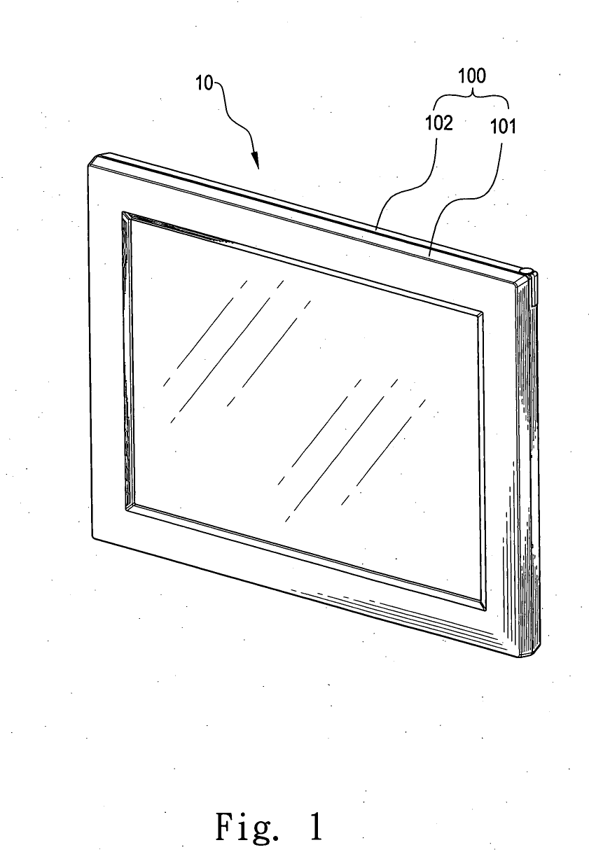

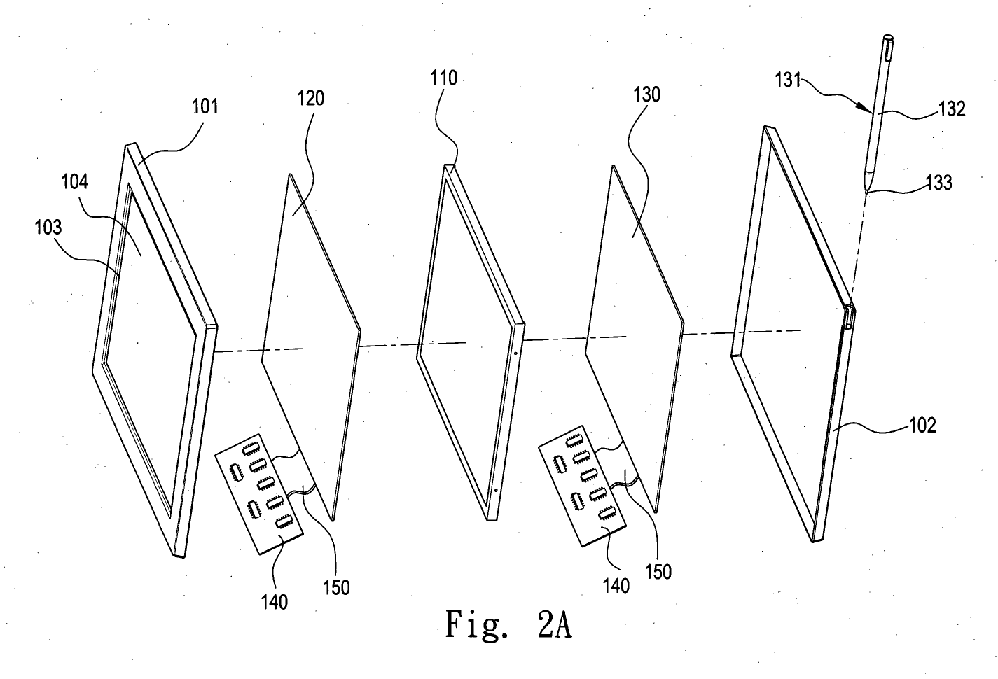

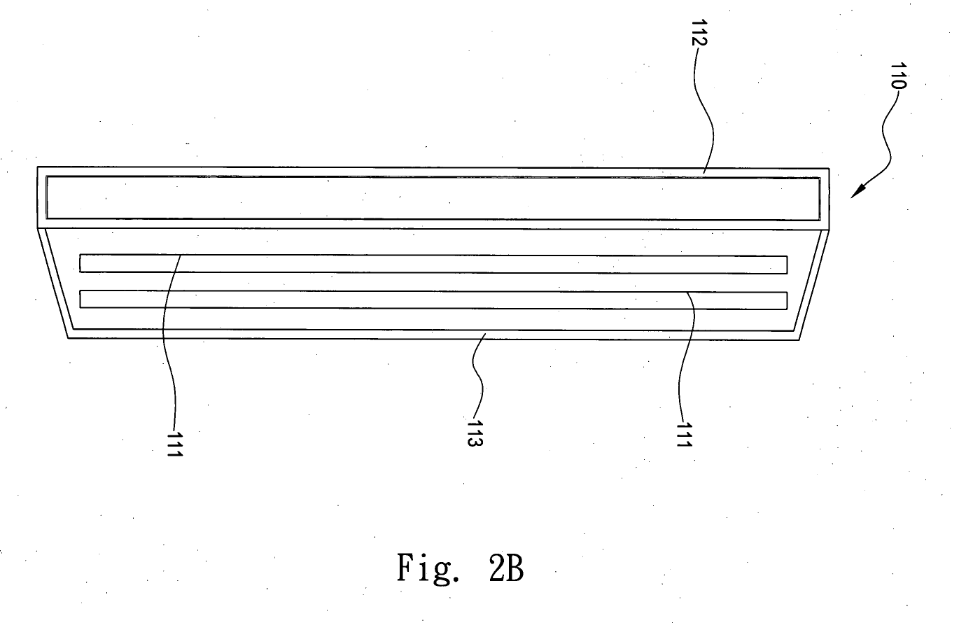

With reference to the drawings and in particular to FIGS. 1-2B, which respectively show a perspective view and an exploded view of a touch display device in accordance with the present invention and a side elevational view of a display unit to which the present invention is embodied, the touch display device of the present invention, generally designated at 10, comprises an enclosure 100, a display unit 110, a finger-operation detector 120, a stylus-operation detector 130, and at least one control circuit 140 for realizing two types of touch control operations of finger operation and stylus operation in an electronic device, such as a notebook computer.

The enclosure 100 is composed of a front cover 101 and a rear cover 102. The front cover 101 forms an opening 103 and comprises a transparent panel 104, which is set in and covers the opening 103.

The display unit 110 is arranged between the front cover 101 and the rear cover 102 and comprises light sources 111, a display panel 112, and a backlight plate 113. The light sources 111 are arranged between the display panel 112 and the backlight plate 113. The display panel 112 is arranged to oppose the transparent panel 104 of the front cover 101.

The finger-operation detector 120 is arranged on the display panel 112 of the display unit 110 and is located between the display unit 110 and the front cover 101. The finger-operation detector 120 is electrically connected to the control circuit 140 through a flexible printed circuit (FPC) 150. The finger-operation detector 120 can be capacitive type, resistive type, or infrared type. The control circuit 140 may comprise a decoding chip and a USB (Universal Serial Bus) switch chip.

The stylus-operation detector 130 can be inductive type or electromagnetic type and is arranged on the backlight plate 113 of the display unit 110 and electrically connected to the control circuit 140 through an FPC 150. The stylus-operation detector 130 comprises a stylus 131, which comprises a handheld section 132 and a touch section 133. In the instant embodiment, the stylus 131 is provided with a power source, such as a battery or a cell (not shown in the drawings) to realize magnetic detection. Alternatively, the stylus 131 can be a non-batteryed stylus. The stylus 131 may comprise a signal transmitter, and the stylus-operation detector 130 comprises a signal receiver; alternatively, the stylus 131 comprises a signal receiver, while the stylus-operation detector 130 comprises a signal transmitter (not shown in the drawings), whereby the signal transmitter may transmit a signal to the signal receiver to identify the location of touch or contact, and the control circuit 140 may comprise a decoding chip and a USB switch chip. Further, the stylus-operation detector 130 can be directly mounted to the backlight plate 113 of the display unit 110, or the backlight plate 113 of the display unit 110 forms a recess into which the stylus-operation detector is fit for mounting.

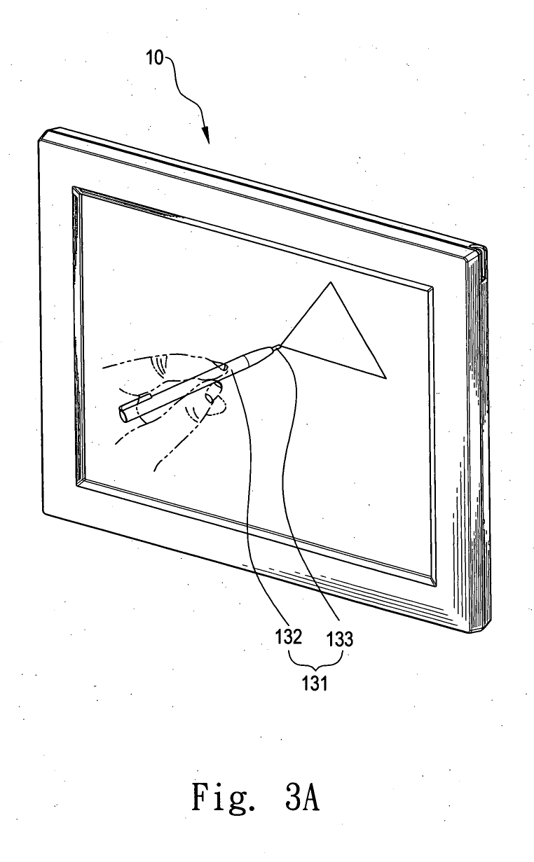

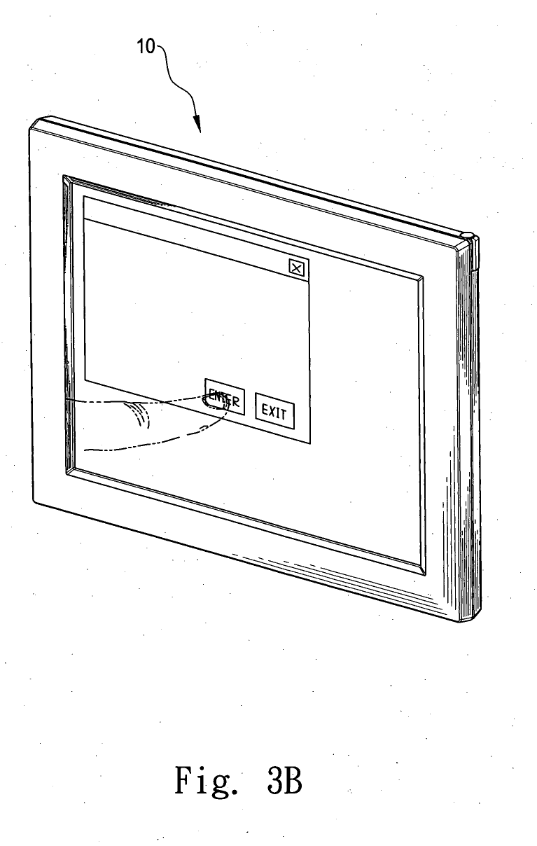

Referring to FIGS. 2A, 3A, and 3B, the dual type touch display device 10 is constructed in such a way that the finger-operation detector 120 and the stylus-operation detector 130 are respectively coupled to the display panel 112 and the backlight plate 113 of the display unit 110, and the finger-operation detector 120 and the stylus-operation detector 130 are respectively and electrically connected to the decoding chips and the USB switch chips of the control circuit 140 through the FPCs 150, whereby a user contacts a touch site on the dual type touch display device 10, the location of the touch site can be easily identified.

In operation, when a user holds the handheld section 132 of the stylus 131 with his or her hand, and perform contact with the dual type touch display device 10 with the touch section 133 of the stylus 131, preset algorithms, such as American Standard Code for Information Interchange (ASCII), are executed in the decoding chips of the control circuit 140 to determine if the touch site is located on the stylus-operation detector 130 in order to activate the stylus-operation detector 130 for identify the location of the touch site and the USB switch chips of the control circuit 140 transmits a control signal representing the touch site to a central processing unit of a notebook computer. Alternatively, if the user touches the dual type touch display device 10 with his or her finger, the decoding chips of the control circuit 140 execute the algorithms to determine if the touch site is located on the finger-operation detector 120 in order to then activate the finger-operation detector 120 to identify the location of the touch site, and the USB switch chips of the control circuit 140 transmits a control signal representing the touch site to a central processing unit of a notebook computer. In other words, the user may perform a multi touch control mode or a single touch control mode through the finger-operation detector 120 and the stylus-operation detector 130, so that two different types of operation of both finger-operation control and stylus-operation control can be carried out to realize dual type touch operation.

Further, the display unit 110 of the present invention that is coupled to both the finger-operation detector 120 and the stylus-operation detector 130 is arranged between the front cover 101 and the rear cover 102 so as to be tightly enclosed by the enclosure 100 for protection against invasion of dust, debris, and humidity.

To summarize, the dual type touch display device in accordance with the present invention features that an enclosure composed of a front cover and a rear cover is provided, a display unit is arranged between the front cover and the rear cover, the display unit comprises a display panel and a backlight plate, and a finger-operation detector is mounted to the display panel of the display unit and a stylus-operation detector is mounted to the backlight plate of the display unit so that the finger-operation detector and the stylus-operation detector may detect sites of touch applied thereto and a dual type touch display device that may operate with multi touches or single touch is realized, which works for different types of operation of both finger operation control or stylus operation control to thus provide a dual type touch display that is operable with single touch and multiple touches, thereby offering the advantages of easy operation and reduction of cost and providing the present invention with practicability, improvement, and convenience.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A dual type touch display device, comprising:
an enclosure, which comprises a front cover and a rear cover;
a display unit, which is arranged between the front cover and the rear cover and comprises a light source, a display panel, and a backlight plate, the light source being arranged between the display panel and the backlight plate and emitting light toward the display panel;
a finger-operation detector, which is arranged on the display panel of the display unit; and
a stylus-operation detector, which is arranged on the backlight plate of the display unit;
wherein the finger-operation detector and the stylus-operation detector are independently operable to detect a site of touch applied thereto to thereby provide a dual type touch display device that realizes both multi-touch operation and single-touch operation.

2. The dual type touch display device as claimed in claim 1, wherein the front cover comprises a transparent panel and forms an opening that receives and retains the transparent panel.

3. The dual type touch display device as claimed in claim 1, wherein the finger-operation detector is selected from a group consisting of capacitive type, resistive type, and infrared type.

4. The dual type touch display device as claimed in claim 1, wherein the stylus-operation detector comprises a stylus.

5. The dual type touch display device as claimed in claim 4, wherein the stylus comprises a handheld section and a touch section.

6. The dual type touch display device as claimed in claim 4, wherein the stylus-operation detector is selected from a group consisting of a battery-powered stylus and a non-batteryed stylus.

7. The dual type touch display device as claimed in claim 1, wherein the stylus-operation detector is selected from a group consisting of inductive type and electromagnetic type.

8. The dual type touch display device as claimed in claim 1 further comprising at least one control circuit, which are electrically connected by flexible printed circuits to the finger-operation detector and the stylus-operation detector.

9. The dual type touch display device as claimed in claim 8, wherein the control circuit comprises a decoding chip and a universal serial bus switch chip.

10. The dual type touch display device as claimed in claim 1, wherein the backlight plate of the display unit forms a recess into which the stylus-operation detector is fit for mounting.
